(19) United States
(12) Patent Application Publication
(10) Pub. No.: US 2012/0074206 A1
(43) Pub. Date: Mar. 29, 2012

(54) METHODS OF FORMING WIRE BONDS FOR WIRE LOOPS AND CONDUCTIVE BUMPS

(75) Inventors: Wei Qin, Lansdale, PA (US); Jon W. Brunner, Sellersville, PA (US); Paul A. Reid, Hatboro, PA (US)

(73) Assignee: KULICKE AND SOFFA INDUSTRIES, INC., Fort Washington, PA (US)

(21) Appl. No.: 13/235,844

(22) Filed: Sep. 19, 2011

Related U.S. Application Data
(60) Provisional application No. 61/386,701, filed on Sep. 27, 2010.

(51) Int. Cl. B23K 31/12; B23K 20/00; B23K 20/10

(52) U.S. Cl. 228/102

(57) ABSTRACT

A method of forming a wire bond using a wire bonding machine is provided. The method includes the steps of: (1) selecting at least one target bonding control value; (2) generating bonding parameters for forming a wire bond using an algorithm and the at least one selected target bonding control value; (3) forming a wire bond using the generated bonding parameters; (4) determining if the at least one selected target bonding control value of the formed wire bond is within a predetermined tolerance of the at least one selected target bonding control value; (5) adjusting at least one bonding adjustment value if the at least one selected target bonding control value of the formed wire bond is not within the predetermined tolerance; and (6) generating revised bonding parameters for forming a subsequent wire bond using an algorithm and the at least one adjusted bonding adjustment value

### CROSS-REFERENCE TO RELATED APPLICATION

This application claims the benefit of Provisional Application No. 61/386,701, filed Sep. 27, 2010, the contents of which is incorporated herein by reference.

### FIELD OF THE INVENTION

The present invention relates to the formation of wire bonds for wire loops and conductive bumps, and more particularly, to improved methods of forming such wire bonds.

### BACKGROUND OF THE INVENTION

In the processing and packaging of semiconductor devices, wire bonding continues to be the primary method of providing electrical interconnection between two locations within a package (e.g., between a die pad of a semiconductor die and a lead of a leadframe). More specifically, using a wire bonder (also known as a wire bonding machine) wire loops are formed between respective locations to be electrically interconnected. The primary methods of forming wire loops are ball bonding and wedge bonding.

An exemplary conventional ball bonding sequence includes: (1) forming a free air ball on an end of a wire extending from a bonding tool; (2) forming a first bond on a die pad of a semiconductor die using the free air ball; (3) extending a length of wire in a desired shape between the die pad and a lead of a leadframe; (4) stitch bonding the wire to the lead of the leadframe; and (5) severing the wire. In forming the bonds between (a) the ends of the wire loop and (b) the bond sites (e.g., a die pad, a lead, etc.) varying types of bonding energy may be used including, for example, ultrasonic energy, thermosonic energy, thermocompressive energy, amongst others.

In connection with the formation of wire bonds (e.g., a ball bond, a stitch bond, etc.), bonding parameters (e.g., bond force, ultrasonic energy, etc.) are used. Often, certain bonding parameters are input into a bonding program by an operator or other user of the wire bonding machine. However, the selected bonding parameters may not provide a desirable wire bond. Subsequent variation of the bonding parameters in an attempt to improve the wire bond typically involves guesswork of the operator.

Thus, it would be desirable to provide improved methods of forming wire bonds in connection with the formation of wire loops or conductive bumps.

### SUMMARY OF THE INVENTION

According to an exemplary embodiment of the present invention, a method of forming a wire bond using a wire bonding machine is provided. The method includes the steps of: (1) selecting at least one target bonding control value; (2) generating bonding parameters for forming a wire bond using an algorithm and the at least one selected target bonding control value; (3) forming a wire bond using the generated bonding parameters; (4) determining if the at least one selected target bonding control value of the formed wire bond is within a predetermined tolerance of the at least one selected target bonding control value; (5) adjusting at least one bonding adjustment value if the at least one selected target bonding control value of the formed wire bond is not within the predetermined tolerance; and (6) generating revised bonding parameters for forming a subsequent wire bond using an algorithm and the at least one adjusted bonding adjustment value.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIGS. 1A-1D are block diagram views of ball bonds useful in explaining methods of forming wire bonds in accordance with certain exemplary embodiments of the present invention;

FIGS. 2A-2C are block diagram screen shots of a wire bonding machine illustrating a method of forming a wire bond in accordance with an exemplary embodiment of the present invention; and

FIGS. 3-5 are flow diagrams illustrating methods of forming wire bonds in accordance with various exemplary embodiments of the present invention.

### DETAILED DESCRIPTION OF THE INVENTION

In accordance with certain exemplary embodiments of the present invention, processes for forming wire bonds (e.g., ball bonds of wire loops, ball bonds of conductive bumps, etc.) are provided. More specifically, methods of forming wire bonds are provided that incorporate process knowledge from previous testing and development work, for example, where such process knowledge may be stored in data structures such as database structures, look-up tables, etc. The process knowledge information stored in the data structures may be used in connection with response based bond parameter optimization techniques. That is, certain information is provided (e.g., provided in the form of a response by a user of the wire bonding machine) related to wire bonds that have been formed. This information is provided to an algorithm(s) which can use the information in connection with the process knowledge stored in the data structures to provide revised bonding parameters.

In certain exemplary embodiments of the present invention, and in contrast to conventional wire bonding methods, bonding parameters are not input parameters. Instead, the inventive input parameters are desirable bonding responses such as a target bonded ball diameter. The stored process knowledge in the data structures typically includes data related to a collection of wire bonding applications with multiple wire diameters, wire types, pad materials, etc. An algorithm(s) uses the inventive input parameters and the stored process knowledge to derive bonding parameters to achieve the desired wire bond characteristics (e.g., the desired bonded ball diameter). The initial derived bonding parameters may not achieve desired wire bond characteristics, and as such, the algorithm(s) may derive revised bonding parameters after receiving bonding adjustment values (e.g., from a user of a wire bonding machine).

As used herein, the term “target bonding control value” is intended to refer to a value provided to a wire bonding system useful in connection with an algorithm(s) to provide bonding parameters for forming a wire bond. Such values relate to a characteristic of a wire bond (e.g., a characteristic of a ball bond). Examples of target bonding control values include a bonded ball diameter value and a bonded ball shear strength value.

As used herein, the term “bonding adjustment value” is intended to refer to an adjustment made to a wire bond characteristic useful in connection with an algorithm(s) to provide revised bonding parameters for forming a wire bond. Examples of bonding adjustment values include (a) a bonded ball strength adjustment, (b) a bonded ball diameter adjustment, (c) a bonded ball height adjustment, (d) an intermetallic profile adjustment, and (e) a bond pad splash adjustment.

As used herein, the term “wire bond characteristic” is intended to refer to a characteristic of a wire bond (e.g., a ball bond) such as (a) a bonded ball strength, (b) a bonded ball diameter, (c) a bonded ball height, (d) an intermetallic profile, and (e) a bond pad splash.

As used herein, the term “bonding parameter” (which is known to those skilled in the art) is intended to refer to a parameter used by a wire bonding machine in the formation of a wire bond (e.g., a ball bond). Examples of bonding parameters include (a) a bond time for forming a wire bond, (b) an ultrasonic energy profile for forming a wire bond, (c) a velocity profile of a bonding tool as it approaches a bonding location for forming a wire bond, (d) a free air ball size where the free air ball is used to form a wire bond, (e) an electronic flame-off energy profile for forming a free air ball, and (f) a bonding force profile for forming a wire bond.

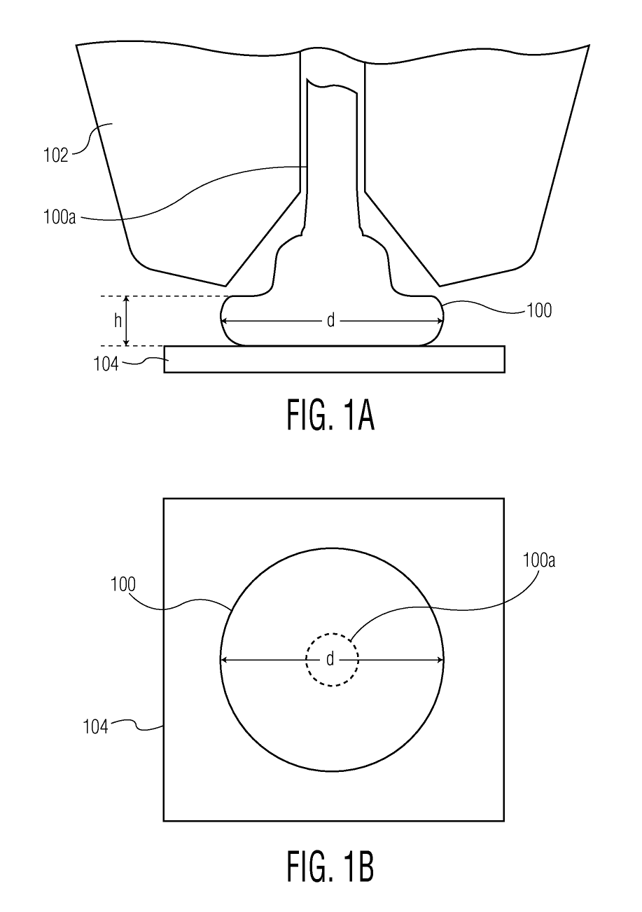

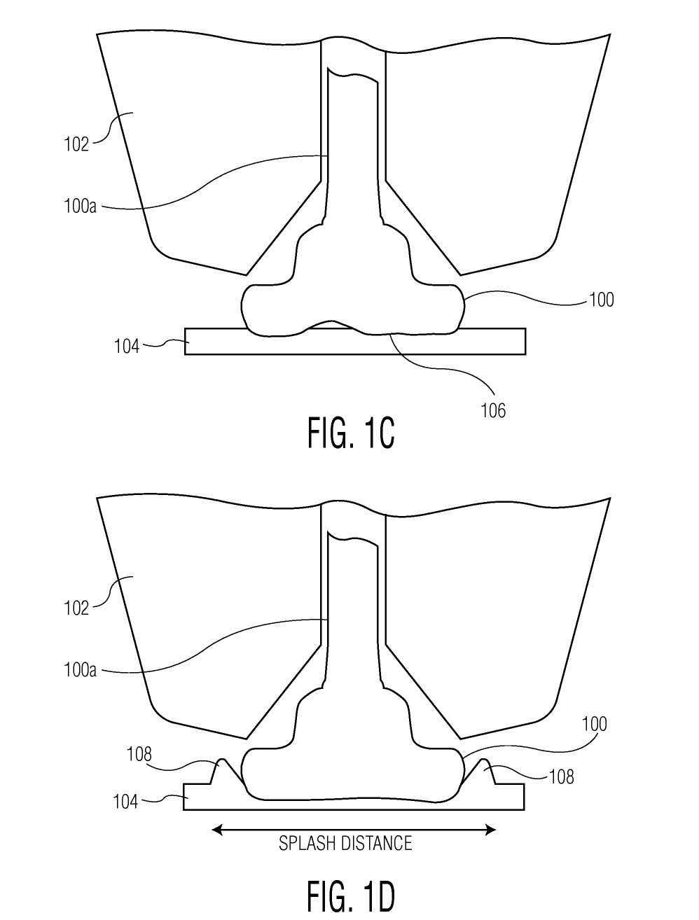

FIG. 1A illustrates wire bond 100 formed on bonding location 104 (e.g., bond pad/die pad 104) using bonding tool 102 (where tool 102 is shown in simplified form). More specifically, a free air ball (not shown) is formed on an end of wire 100a using an electronic flame-off assembly or the like. The free air ball is seated at the tip of bonding tool 102 and is then lowered to bonding location 104, hereinafter referred to as bond pad 104 (but other types of bonding locations, other than bond pads, are contemplated). The free air ball is bonded to bond pad 104 using, for example, bonding force, ultrasonic energy, etc. In such a manner, wire bond 100 (which may also be termed bonded ball 100, or ball bond 100) is formed and is defined by bonded ball diameter “d” (i.e., the diameter of the bonded ball at its widest portion, typically the center of the bonded ball) and bonded ball height “h”. Diameter “d” is also shown in the top view of bonded ball 100 in FIG. 1B.

FIG. 1C illustrates a potential problem during the formation of bonded ball 100. More specifically, interface 106 is provided between a portion of bonded ball 100 and bond pad 104. Interface 106 is illustrated to indicate poor intermetallic connection between bonded ball 100 and bond pad 104, and may result in a poor electrical connection, peeling of bonded ball 100 from bond pad 104, etc. FIG. 1D illustrates pad splash 108. That is, when the free air ball (which becomes bonded ball 100) is bonded to bond pad 104 this may result in “pad splash” which relates to an undesirable level of disruption of the material of bond pad 104 during the bonding process. Problems with pad splash tend to be made worse during copper wire bonding due to the hardness of the copper wire. FIG. 1D illustrates a “splash distance” to indicate the extent across bond pad 104 that the pad splash has reached.

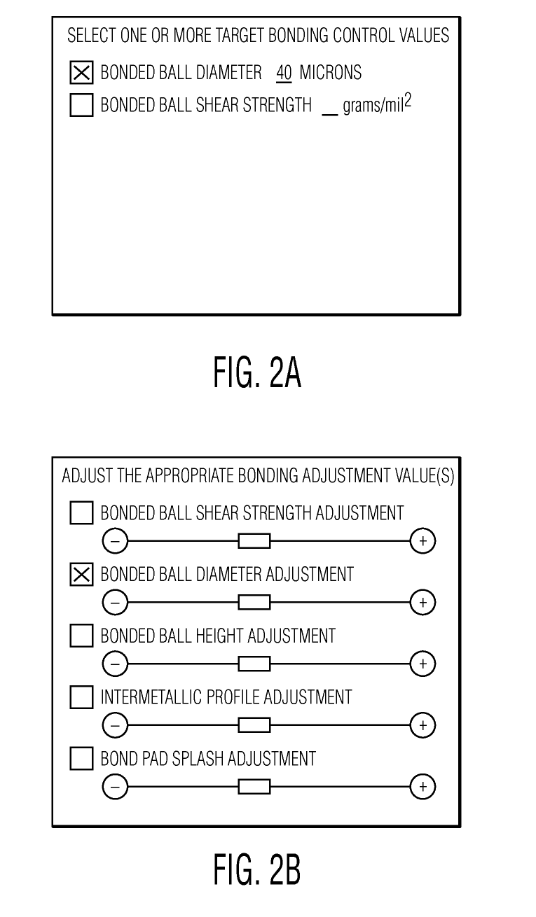

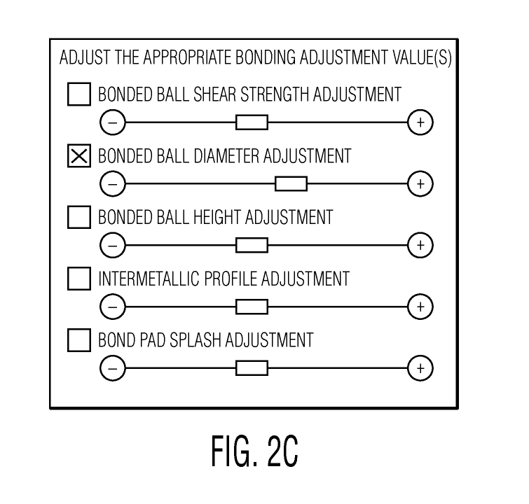

FIG. 2A-2C are simplified screen shots of a wire bonding machine which illustrate exemplary wire bonding techniques. At FIG. 2A, a user (e.g., an operator of a wire bonding machine) selects one or more “target bonding control values.” In the illustrated example, two possible target bonding control values (bonded ball diameter and bonded ball shear strength) are illustrated; however, it is understood that additional and/or different values may be provided. In FIG. 2A, the user has selected bonded ball diameter as the target bonding control value, and has input a target value of 40 microns. With the selected target control value (and possibly other information such as wire material and diameter) an algorithm of the wire bonding machine generates bonding parameters for formation of a wire bond (e.g., a ball bond of a wire loop). After formation of a wire bond (or a number of wire bonds) a user analyzes the formed wire bond(s) to determine if the wire bond(s) meets certain criteria. For example, the criteria/characteristics may include (but not be limited to) the target bonding control value or other criteria/characteristics. Examples of such criteria/characteristics may relate to the the bonded ball shear strength, bonded ball diameter, the bonded ball height, the intermetallic profile, and the bond pad splash. If certain of these criteria/characteristics are not desirable the user may adjust the criteria/characteristics, where the user's adjustment results in varied bonding parameters as determined by an algorithm of the wire bonding machine. More specifically, in FIG. 2B the user is provided with an opportunity to vary one or more of several bonding adjustment values. In the illustrated example, the exemplary bonding adjustment values include a bonded ball shear strength adjustment, a bonded ball diameter adjustment, a bonded ball height adjustment, an intermetallic profile adjustment, and a bond pad splash adjustment.

After the ball bond is formed (with the target bonded ball diameter of 40 microns as shown in FIG. 2A), assume that the actual bonded ball diameter is actually 38 microns. In such a case, the use may desire to modify or adjust the bonded ball diameter. As seen in FIG. 2B, the user selects the bonded ball diameter adjustment. As shown in FIG. 2B, a GUI (graphical user interface) is provided that allows the user to hit (or otherwise engage) a plus sign (“+”) to raise the bonded ball diameter or a minus sign (“−”) to lower the bonded ball diameter. Of course, any type of interface may be provided to adjust the bonding adjustment values. In FIG. 2C, it is seen that the user has raised the bonded ball diameter. Such a change will result in variation of certain bonding parameters as determined by the algorthm(s) of the wire bonding machine such that the bonded ball diameter may be increased (e.g., closer to the desired bonded ball diameter of 40 microns).

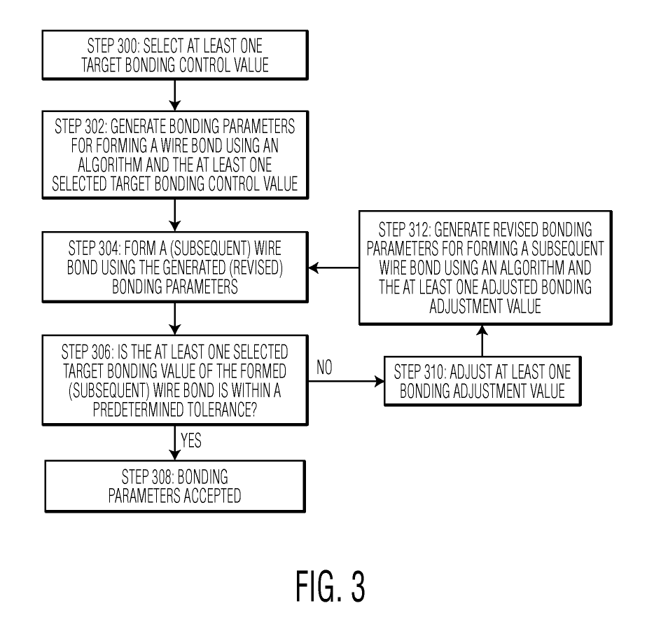

FIGS. 3-5 are flow diagrams illustrating methods of forming wire bonds in accordance with certain exemplary embodiments of the present invention. As is understood by those skilled in the art, certain steps included in the flow diagrams may be omitted; certain additional steps may be added; and the order of the steps may be altered from the order illustrated.

At Step 300 in FIG. 3, at least one target bonding control value (e.g., bonded ball diameter, bonded ball shear strength, etc) is selected. Referring back to FIG. 2A, the user selected the target bonding control value to be the bonded ball diameter, and has selected the target to be 40 microns. At Step 302, bonding parameters for forming a wire bond using an algorithm and the at least one selected target bonding control value are generated. At Step 304, a wire bond (or a group of wire bonds) is formed using the generated bonding parameters. At Step 306, a determination is made as to whether the at least one selected target bonding control value of the formed wire bond is within a predetermined tolerance. If the answer to the question at Step 306 is “Yes” then the bonding parameters are accepted at Step 308. If the answer to the question at Step 306 is “No” then at Step 310 at least one of the bonding adjustment values are adjusted. At Step 312, revised bonding parameters are generated for a subsequent wire bond using an algorithm and the at least one adjusted bonding adjustment value. Then, a subsequent bond(s) is formed at Step 304 and the process continues until the determination made at Step 306 is affirmative and the bonding parameters are accepted at Step 308.

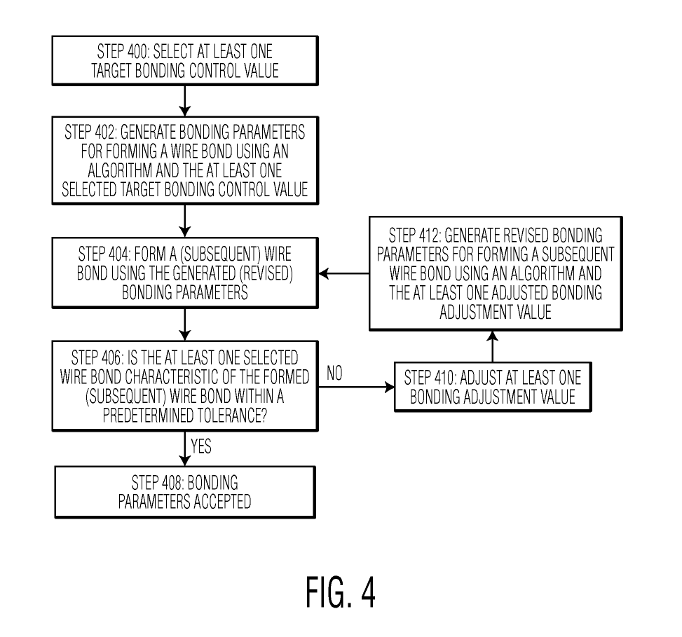

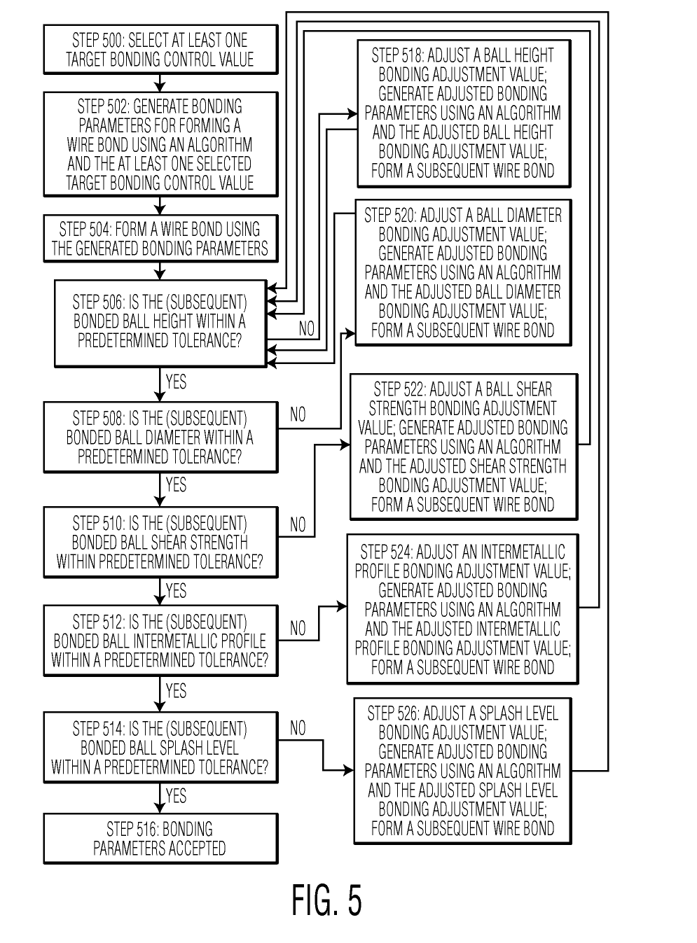

In Step 306 the determination was made as to whether the at least one selected target bonding control value of the formed wire bond is within a predetermined tolerance; however, additional or different determinations may be made with respect to the formed wire bond. For example, in Step 406 of FIG. 4, a determination is made as to whether at least one wire bond characteristic of the formed wire bond is within a predetermined tolerance. Further, in FIG. 5, examples of such determinations from Step 406 of FIG. 4 are shown at Steps 506, 508, 510, 512, and 514.

At Step 400 in FIG. 4, at least one target bonding control value (e.g., bonded ball diameter, bonded ball shear strength, etc) is selected. Referring back to FIG. 2A, the user selected the target bonding control value to be the bonded ball diameter, and has selected the target to be 40 microns. At Step 402, bonding parameters for forming a wire bond using an algorithm and the at least one selected target bonding control value are generated. At Step 404, a wire bond (or a group of wire bonds) are formed using the generated bonding parameters. At Step 406, a determination is made as to whether the at least one selected wire bond characteristic of the formed wire bond is within a predetermined tolerance. If the answer to the question at Step 406 is “Yes” then the bonding parameters are accepted at Step 408. If the answer to the question at Step 406 is “No” then at Step 410 at least one of the bonding adjustment values are adjusted at Step 410. At Step 412, revised bonding parameters are generated for a subsequent wire bond using an algorithm and the at least one adjusted bonding adjustment value. Then, a subsequent bond(s) is formed at Step 404 and the process continues until the determination made at Step 406 is affirmative and the bonding parameters are accepted at Step 408.

Step 406 in FIG. 4 may be replaced by a number of determinations regarding characteristics of a formed wire bond(s). Steps 506, 508, 510, 512, and 514 in FIG. 5 are examples of such determinations. Referring to FIG. 5, at Step 500 at least one target bonding control value (e.g., bonded ball diameter, bonded ball shear strength, etc) is selected. At Step 502, bonding parameters for forming a wire bond using an algorithm and the at least one selected target bonding control value are generated. At Step 504, a wire bond (or a group of wire bonds) is formed using the generated bonding parameters. At Step 506, a determination is made as to whether the bonded ball height is within a predetermined tolerance. If the answer to the question at Step 506 is “Yes” then the process proceeds to Step 508. If the answer to the question at Step 506 is “No” then at Step 518 a ball height bonding adjustment value is adjusted (e.g., in a manner similar to that illustrated in FIG. 2B). Then, adjusted bonding parameters are generated using an algorithm and the adjusted ball height bonding adjustment value. Then, a subsequent wire bond(s) is formed and the process returns to Step 506. This process continues until an affirmative response is provided at Step 506, where the process can then proceed to Step 508.

At Step 508, a determination is made as to whether the bonded ball diameter is within a predetermined tolerance. If the answer to the question at Step 508 is “Yes” then the process proceeds to Step 510. If the answer to the question at Step 508 is “No” then at Step 520 a ball diameter bonding adjustment value is adjusted (e.g., in a manner similar to that illustrated in FIG. 2B). Then, adjusted bonding parameters are generated using an algorithm and the adjusted ball diameter bonding adjustment value. Then, a subsequent wire bond(s) is formed and the process returns to Step 506. This process continues until an affirmative response is provided at each of Steps 506 and 508, where the process can then proceed to Step 510.

At Step 510, a determination is made as to whether the bonded ball shear strength is within a predetermined tolerance. If the answer to the question at Step 510 is “Yes” then the process proceeds to Step 512. If the answer to the question at Step 510 is “No” then at Step 522 a ball shear strength bonding adjustment value is adjusted (e.g., in a manner similar to that illustrated in FIG. 2B). Then, adjusted bonding parameters are generated using an algorithm and the adjusted ball shear strength bonding adjustment value. Then, a subsequent wire bond(s) is formed and the process returns to Step 506. This process continues until an affirmative response is provided at each of Steps 506, 508 and 510, where the process can then proceed to Step 512.

At Step 512, a determination is made as to whether the bonded ball intermetallic profile is within a predetermined tolerance. If the answer to the question at Step 512 is “Yes” then the process proceeds to Step 514. If the answer to the question at Step 512 is “No” then at Step 524 an intermetallic profile bonding adjustment value is adjusted (e.g., in a manner similar to that illustrated in FIG. 2B). Then, adjusted bonding parameters are generated using an algorithm and the adjusted intermetallic profile bonding adjustment value. Then, a subsequent wire bond(s) is formed and the process returns to Step 506. This process continues until an affirmative response is provided at each of Steps 506, 508, 510 and 512, where the process can then proceed to Step 514.

At Step 514, a determination is made as to whether the bonded ball bond pad splash level is within a predetermined tolerance. If the answer to the question at Step 514 is “Yes” then the process proceeds to Step 516, and the bonding parameters are accepted. If the answer to the question at Step 514 is “No” then at Step 526 a splash level bonding adjustment value is adjusted (e.g., in a manner similar to that illustrated in FIG. 2B). Then, adjusted bonding parameters are generated using an algorithm and the adjusted splash level bonding adjustment value. Then, a subsequent wire bond(s) is formed and the process returns to Step 506. This process continues until an affirmative response is provided at each of Steps 506, 508, 510, 512 and 514, where the process can then proceed to Step 516, and the bonding parameters are accepted.

It will be appreciated that the determinations made at each of Steps 506, 508, 510, 512, and 514 are not limiting. That is, only a portion of these determinations may be made in a given method. Further, additional or different determinations may be made.

In FIG. 5, each of the determinations made at each of Steps 506, 508, 510, 512, and 514 is satisfied before the method can proceed to the next determination. That is, an affirmative response must be provided at Step 506 before the method can proceed to the determination to be made at Step 508, and so on. However, such an approach is not required. That is, each of the determinations may be made individually (and appropriate adjustments may be made), and then after all of the determinations are made (in Steps 506, 508, 510, 512, 514) and all of the appropriate adjustments may be made (in Steps 518, 520, 522, 524, 526), the bonding parameters may then be varied/adjusted.

Using the methods provided herein, improved wire bonding results may be achieved, particularly in connection with copper wire bonding. Exemplary improvements include improved UPH (units per hour), improved consistency in wire bonding results, decreased yield loss, amongst others.

Although the techniques disclosed herein have largely been described in connection with the formation (and analysis) of a single wire bond, the present invention is not limited thereto. That is, it is clear that it may be desirable to form a plurality of wire bonds using the initial generated bonding parameters. Then, wire bond characteristics of the plurality of wire bonds (and not a single wire bond) can be analyzed. This may provide for a more accurate methodology. For example, a determination may be made as to whether an aggregate of the at least one selected target bonding control value (and/or of the at least one selected wire bond characteristic) of the plurality of formed wire bonds is within a predetermined tolerance. Such an aggregate approach may be an averaging approach, a mean value approach, amongst others.

Although the present invention has particular benefits in connection with copper wire bonding, it is not limited thereto. The teachings of the present invention may be applicable to varying types of wire including aluminum, gold, or any of a number of wire materials.

Although the present invention has been described primarily with respect to the formation of a first wire bond of a wire loop, it is not limited thereto. The teachings of the present invention may be applicable varying types of wire bonds including, for example, second bonds of a wire loop, as well as conductive bumps (e.g., stud bumps) formed using a wire bonding or bumping machine.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of forming a wire bond using a wire bonding machine, the method comprising the steps of:
(1) selecting at least one target bonding control value;
(2) generating bonding parameters for forming a wire bond using an algorithm and the at least one selected target bonding control value;
(3) forming a wire bond using the generated bonding parameters;
(4) determining if the at least one selected target bonding control value of the formed wire bond is within a predetermined tolerance of the at least one selected target bonding control value;
(5) adjusting at least one bonding adjustment value if the at least one selected target bonding control value of the formed wire bond is not within the predetermined tolerance; and
(6) generating revised bonding parameters for forming a subsequent wire bond using an algorithm and the at least one adjusted bonding adjustment value.

2. The method of claim 1 wherein step (1) includes selecting the at least one target bonding control value such that the at least one target bonding control value includes at least one of (a) a diameter of a bonded ball of a wire bond, and (b) a shear strength of a wire bond.

3. The method of claim 1 wherein step (1) includes selecting the at least one target bonding control value such that the at least one target bonding control value is a diameter of a bonded ball of a wire bond.

4. The method of claim 1 wherein step (2) includes generating the bonding parameters to include at least one of (a) a bond time for forming a wire bond, (b) an ultrasonic energy profile for forming a wire bond, (c) a velocity profile of a bonding tool as it approaches a bonding location for forming a wire bond, (d) a free air ball size where the free air ball is used to form a wire bond, (e) an electronic flame-off energy profile for forming the free air ball, and (f) a bonding force profile for forming a wire bond.

5. The method of claim 1 wherein the algorithm of step (2) is different from the algorithm of step (6).

6. The method of claim 1 wherein the algorithm of step (2) is the same as the algorithm of step (6).

7. The method of claim 1 wherein step (3) includes forming a plurality of wire bonds using the generated bonding parameters.

8. The method of claim 7 wherein step (4) includes determining if an aggregate of the at least one selected target bonding control value of the plurality of formed wire bonds is within the predetermined tolerance.

9. The method of claim 1 wherein step (4) is performed offline from a wire bonding machine.

10. The method of claim 1 wherein step (4) is performed on a wire bonding machine.

11. The method of claim 1 wherein step (5) includes selecting the at least one bonding adjustment value to include at least one of (a) a bonded ball strength adjustment, (b) a bonded ball diameter adjustment, (c) a bonded ball height adjustment, (d) an intermetallic profile adjustment, and (e) a bond pad splash adjustment.

12. A method of forming a wire bond using a wire bonding machine, the method comprising the steps of:
(1) selecting at least one target bonding control value, the at least one target bonding control value including a diameter of a bonded ball of a wire bond;
(2) generating bonding parameters for forming a wire bond using an algorithm and the at least one selected target bonding control value;
(3) forming a wire bond using the generated bonding parameters;
(4) determining if the at least one selected target bonding control value of the formed wire bond is within a predetermined tolerance of the at least one selected target bonding control value;
(5) adjusting at least one bonding adjustment value if the at least one selected target bonding control value of the formed wire bond is not within the predetermined tolerance; and
(6) generating revised bonding parameters for forming a subsequent wire bond using an algorithm and the at least one adjusted bonding adjustment value.

13. The method of claim 12 wherein step (1) includes selecting the at least one target bonding control value such that the at least one target bonding control value further includes a shear strength of a wire bond.

14. The method of claim 12 wherein step (1) includes selecting the at least one target bonding control value such that the at least one target bonding control value is a diameter of a bonded ball of a wire bond.

15. The method of claim 12 wherein step (2) includes generating the bonding parameters to include at least one of (a) a bond time for forming a wire bond, (b) an ultrasonic energy profile for forming a wire bond, (c) a velocity profile of a bonding tool as it approaches a bonding location for forming a wire bond, (d) a free air ball size where the free air ball is used to form a wire bond, (e) an electronic flame-off energy profile for forming the free air ball, and (f) a bonding force profile for forming a wire bond.

16. The method of claim 12 wherein the algorithm of step (2) is different from the algorithm of step (6).

17. The method of claim 12 wherein the algorithm of step (2) is the same as the algorithm of step (6).

18. The method of claim 12 wherein step (3) includes forming a plurality of wire bonds using the generated bonding parameters.

19. The method of claim 18 wherein step (4) includes determining if an aggregate of the at least one selected target bonding control value of the plurality of formed wire bonds is within the predetermined tolerance.

20. The method of claim 12 wherein step (4) is performed offline from a wire bonding machine.

21. The method of claim 12 wherein step (4) is performed on a wire bonding machine.

22. The method of claim 12 wherein step (5) includes selecting the at least one bonding adjustment value to include at least one of (a) a bonded ball strength adjustment, (b) a bonded ball diameter adjustment, (c) a bonded ball height adjustment, (d) an intermetallic profile adjustment, and (e) a bond pad splash adjustment.

23. A method of forming a wire bond using a wire bonding machine, the method comprising the steps of:
(1) selecting at least one target bonding control value, the at least one target bonding control value including a shear strength of a wire bond;
(2) generating bonding parameters for forming a wire bond using an algorithm and the at least one selected target bonding control value;
(3) forming a wire bond using the generated bonding parameters;
(4) determining if the at least one selected target bonding control value of the formed wire bond is within a predetermined tolerance of the at least one selected target bonding control value;
(5) adjusting at least one bonding adjustment value if the at least one selected target bonding control value of the formed wire bond is not within the predetermined tolerance; and
(6) generating revised bonding parameters for forming a subsequent wire bond using an algorithm and the at least one adjusted bonding adjustment value.

24. The method of claim 23 wherein step (1) includes selecting the at least one target bonding control value such that the at least one target bonding control value further includes a diameter of a bonded ball of a wire bond.

25. The method of claim 23 wherein step (1) includes selecting the at least one target bonding control value such that the at least one target bonding control value is a shear strength of a wire bond.

26. The method of claim 23 wherein step (2) includes generating the bonding parameters to include at least one of (a) a bond time for forming a wire bond, (b) an ultrasonic energy profile for forming a wire bond, (c) a velocity profile of a bonding tool as it approaches a bonding location for forming a wire bond, (d) a free air ball size where the free air ball is used to form a wire bond, (e) an electronic flame-off energy profile for forming the free air ball, and (f) a bonding force profile for forming a wire bond.

27. The method of claim 23 wherein the algorithm of step (2) is different from the algorithm of step (6).

28. The method of claim 23 wherein the algorithm of step (2) is the same as the algorithm of step (6).

29. The method of claim 23 wherein step (3) includes forming a plurality of wire bonds using the generated bonding parameters.

30. The method of claim 29 wherein step (4) includes determining if an aggregate of the at least one selected target bonding control value of the plurality of formed wire bonds is within a predetermined tolerance.

31. The method of claim 23 wherein step (4) is performed offline from a wire bonding machine.

32. The method of claim 23 wherein step (4) is performed on a wire bonding machine.

33. The method of claim 23 wherein step (5) includes selecting the at least one bonding adjustment value to include at least one of (a) a bonded ball strength adjustment, (b) a bonded ball diameter adjustment, (c) a bonded ball height adjustment, (d) an intermetallic profile adjustment, and (e) a bond pad splash adjustment.

34. A method of forming a wire bond using a wire bonding machine, the method comprising the steps of:
(1) selecting at least one target bonding control value;
(2) generating bonding parameters for forming a wire bond using an algorithm and the at least one selected target bonding control value;
(3) forming a wire bond using the generated bonding parameters;
(4) determining if at least one selected wire bond characteristic of the formed wire bond is within a predetermined tolerance of the at least one selected wire bond characteristic;
(5) adjusting at least one bonding adjustment value if the at least one selected wire bond characteristic of the formed wire bond is not within the predetermined tolerance; and
(6) generating revised bonding parameters for forming a subsequent wire bond using an algorithm and the at least one adjusted bonding adjustment value.

35. The method of claim 34 wherein step (1) includes selecting the at least one target bonding control value such that the at least one target bonding control value includes at least one of (a) a diameter of a bonded ball of a wire bond, and (b) a shear strength of a wire bond.

36. The method of claim 34 wherein step (1) includes selecting the at least one target bonding control value such that the at least one target bonding control value is a diameter of a bonded ball of a wire bond.

37. The method of claim 34 wherein step (2) includes generating the bonding parameters to include at least one of (a) a bond time for forming a wire bond, (b) an ultrasonic energy profile for forming a wire bond, (c) a velocity profile of a bonding tool as it approaches a bonding location for forming a wire bond, (d) a free air ball size where the free air ball is used to form a wire bond, (e) an electronic flame-off energy profile for forming the free air ball, and (f) a bonding force profile for forming a wire bond.

38. The method of claim 34 wherein the algorithm of step (2) is different from the algorithm of step (6).

39. The method of claim 34 wherein the algorithm of step (2) is the same as the algorithm of step (6).

40. The method of claim 34 wherein step (3) includes forming a plurality of wire bonds using the generated bonding parameters.

41. The method of claim 40 wherein step (4) includes determining if an aggregate of the at least one selected target bonding control value of the plurality of formed wire bonds is within a predetermined tolerance.

42. The method of claim 34 wherein step (4) is performed offline from a wire bonding machine.

43. The method of claim 34 wherein step (4) is performed on a wire bonding machine.

44. The method of claim 34 wherein step (5) includes selecting the at least one bonding adjustment value to include at least one of (a) a bonded ball strength adjustment, (b) a bonded ball diameter adjustment, (c) a bonded ball height adjustment, (d) an intermetallic profile adjustment, and (e) a bond pad splash adjustment.

45. The method of claim 34 wherein the at least one selected wire bond characteristic includes at least one of (a) a bonded ball strength, (b) a bonded ball diameter, (c) a bonded ball height, (d) an intermetallic profile, and (e) a bond pad splash.
